(19) United States
(12) Patent Application Publication
(10) Pub. No.: US 2026/0268500 A1
(43) Pub. Date: Sep. 10, 2026

(54) FEATURE DETECTION EDGE ENHANCEMENT MECHANISM

(71) Applicants: Walter F. Kailey, Boulder, CO (US); Claudiu Attila Balogh, Timisoara (RO); Mikel Stanich, Boulder, CO (US)

(72) Inventors: Walter F. Kailey, Boulder, CO (US); Claudiu Attila Balogh, Timisoara (RO); Mikel Stanich, Boulder, CO (US)

(73) Assignee: Ricoh Company, Ltd., Tokyo (JP)

(21) Appl. No.: 19/075,224

(22) Filed: Mar. 10, 2025

(51) Int. Cl. G06T 7/13; G06V 10/44; G06V 10/74; G06V 10/764; H04N 1/405

(52) U.S. Cl. CPC G06T 7/13; G06V 10/44; G06V 10/761; G06V 10/764; H04N 1/405; G06T 2207/20192

(57) ABSTRACT

A system is disclosed. The system includes at least one physical memory device to store edge enhancement logic and one or more processors coupled with the at least one physical memory device to execute the edge enhancement logic to perform feature detection processing to identify a plurality of edge pels within a plurality of pels in a continuous tone image (CTI), assign one of a plurality of pel edge symbols to each of the identified pels within the CTI and perform nozzle compensation and edge pel processing for each of the identified edge pels to generate final halftone designs by modifying halftone designs for the identified edge pels with corresponding nozzle compensation data and with edge enhancement compensation data corresponding to the indicated edge type.

### FIELD OF THE INVENTION

The invention relates to the field of image reproduction, and in particular, to image processing.

### BACKGROUND

Entities with substantial printing demands typically implement a high-speed production printer for volume printing (e.g., one hundred pages per minute or more). Production printers may include continuous-forms printers that print on a web of print media (or paper) stored on a large roll. A production printer typically includes a localized print controller that controls the overall operation of the printing system, and a print engine that includes one or more printhead assemblies, where each assembly includes a printhead controller and a printhead (or array of printheads). Each printhead contains many nozzles (e.g., inkjet nozzles) for the ejection of ink or any colorant suitable for printing on a medium.

### SUMMARY

In one embodiment, a system is disclosed. The system includes at least one physical memory device to store edge enhancement logic and one or more processors coupled with the at least one physical memory device to execute the edge enhancement logic to perform feature detection processing to identify a plurality of edge pels within a plurality of pels in a continuous tone image (CTI), assign one of a plurality of pel edge symbols to each of the identified pels within the CTI and perform nozzle compensation and edge pel processing for each of the identified edge pels to generate final halftone designs by modifying halftone designs for the identified edge pels with corresponding nozzle compensation data and with edge enhancement compensation data corresponding to the indicated edge type.

### BRIEF DESCRIPTION OF THE DRAWINGS

A better understanding of the present invention can be obtained from the following detailed description in conjunction with the following drawings, in which:

FIG. 1 is a block diagram of one embodiment of a printing system;

FIG. 2 is a block diagram of one embodiment of a print controller;

FIG. 3A illustrates one embodiment of multibit halftone designs, where the halftones are described using multi-bit threshold arrays (MTAs);

FIG. 3B illustrates one embodiment of edge detection for a contone image;

FIG. 3C illustrates one embodiment of an edge enhancement inverse transfer function;

FIG. 3D illustrates one embodiment of generating an edge enhanced threshold;

FIG. 3E illustrates one embodiment of a halftoning result;

FIG. 3F illustrates one embodiment of an edge enhanced halftoning result;

FIG. 4 illustrates one embodiment of a compensation module;

FIG. 5 illustrates one embodiment of an edge enhancement module;

FIG. 6 is a flow diagram illustrating one embodiment of an edge identification process;

FIG. 7 illustrates one embodiment of edge enhancement logic;

FIGS. 8A&9B is a flow diagram illustrating one embodiment of an edge enhancement process;

FIGS. 9A&9B is a flow diagram illustrating another embodiment of an edge enhancement process; and

FIG. 10 illustrates one embodiment of a computer system.

### DETAILED DESCRIPTION

Prior to commencing printing operations, uniformity compensation may be performed to compensate for measured response differences for a print head nozzle which is not jetting properly. As used herein, uniformity compensation is defined as a calibration to compensate for measured response (e.g., optical density) differences at a single pel, by a corresponding pel forming element (e.g., print head nozzle). Uniformity compensation methods are based on uniformity compensation of nozzles, which may comprise modifying (e.g., adjusting, lowering or raising) halftone thresholds (e.g., thresholds) proportional to a nozzle's intrinsic density (e.g., lower threshold results in a higher density).

However, various nozzles may become defective during printer operation, which may lead to undesired changes in jetting output (e.g., ink deposition artifacts such as jet-outs or deviated jets) caused by the defective nozzles. Thus, jet-out compensation may comprise lowering the halftone thresholds of nozzles that are adjacent to the defective nozzle (or neighboring nozzles) and disabling the jet-out column of the defective nozzle. Jet-out compensation may alternatively comprise modifying the contone image pel value for pels that correspond to nozzles adjacent to the defective nozzle to increase their ink output and disabling the jet-out column of the defective nozzle. Disabling the jet-out column avoids unintentionally cleaning and activating the defective nozzle, which may create undesirable density variations in the printed output.

Edge enhancement may also be performed to enhance edge contrast of data to enhance print quality of images that are to be printed. Edge enhancement involves detecting edge pixels in a continuous tone image and performing an edge pixel specific halftoning operation on the detected pixels. However, edge enhancement may negate the results of the uniformity compensation and/or jet-out compensation processes and produce undesirable print quality according to conventional methods. For example, conventional methods of combining edge enhancement compensation with jet-out compensation may result in instructing a jet-out nozzle to eject ink even if the jet-out compensation applied by itself would result in no instruction to the jet-out nozzle to eject ink. In another example, conventional methods of combining edge enhancement compensation with uniformity compensation may result in a nozzle that does not have a calibrated response even though the uniformity compensation by itself would result in the same nozzle having a calibrated response. In both examples, the result is degraded observable print quality.

According to one embodiment, a feature detection mechanism is described to identify a type of edge pel (or identified edge pel) and perform edge enhancement based on the type of edge pel to maintain uniformity compensation and jet-out compensation of nozzles during edge enhancement. In the following description, for the purposes of explanation, numerous specific details are set forth to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

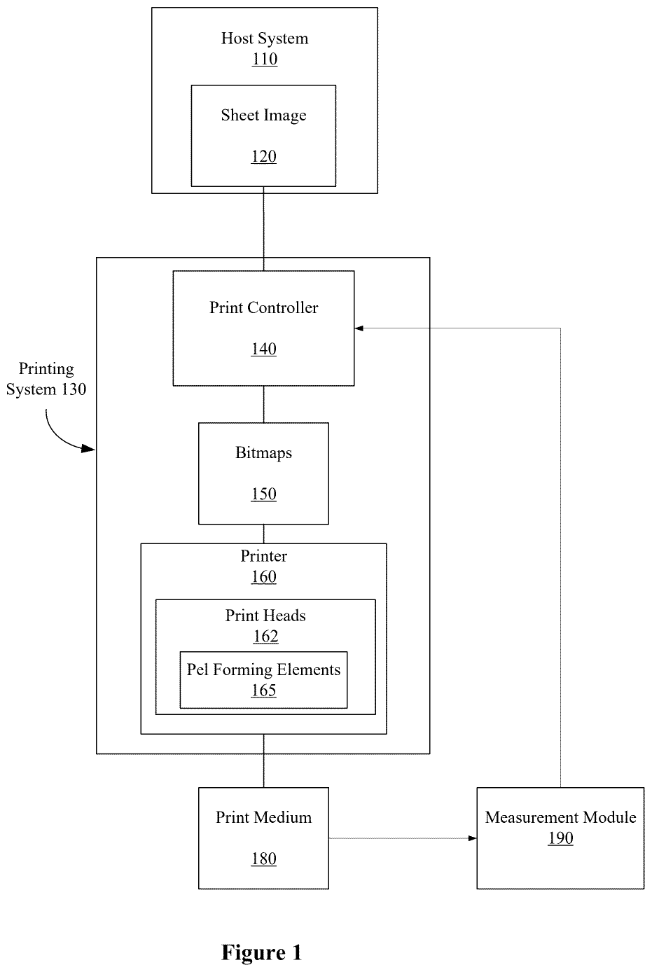

FIG. 1 is a block diagram illustrating one embodiment of a printing system 130. A host system 110 is in communication with the printing system 130 to print a sheet image 120 onto a print medium 180 via a printer 160 (e.g., one or more print engines). Print medium 180 may include paper, card stock, paper board, corrugated fiberboard, film, plastic, synthetic, textile, glass, composite or any other tangible medium suitable for printing. The format of print medium 180 may be continuous form or cut sheet or any other format suitable for printing. Printer 160 may be an ink jet, electrophotographic or another suitable printer type.

In one embodiment, printer 160 comprises one or more print heads 162, each including one or more pel forming elements 165 that directly or indirectly (e.g., by transfer of marking material through an intermediary) forms the representation of picture elements (pels) on the print medium 180 with marking material applied to the print medium. In an ink jet printer, the pel forming element 165 is a tangible device that ejects the ink onto the print medium 180 (e.g., an ink jet nozzle) and, in an electro-photographic (EP) printer the pel forming element may be a tangible device that determines the location of toner particles printed on the print medium (e.g., an EP exposure LED or an EP exposure laser). The pel forming elements may be grouped onto one or more printheads 162. The pel forming elements 165 may be stationary (e.g., as part of a stationary printhead 162) or moving (e.g., as part of a printhead 162 that moves across the print medium 180) as a matter of design choice. Further, the pel forming elements 165 may be assigned to one of one or more color planes that correspond to types of marking materials (e.g., Cyan, Magenta, Yellow, and blacK (CMYK)).

In a further embodiment, printer 160 is a multi-pass printer (e.g., dual pass, 3 pass, 4 pass, etc.) wherein multiple sets of pel forming elements 165 print the same region of the print image on the print medium 180. The set of pel forming elements 165 may be located on the same physical structure (e.g., an array of nozzles on an ink jet print head 162) or separate physical structures. The resulting print medium 180 may be printed in color and/or in any of a number of gray shades, including black and white (e.g., Cyan, Magenta, Yellow, and blacK, (CMYK)). The host system 110 may include any computing device, such as a personal computer, a server, or even a digital imaging device, such as a digital camera or a scanner.

The sheet image 120 may be any file or data that describes how an image on a sheet of print medium 180 should be printed. For example, the sheet image 120 may include PostScript data, Printer Command Language (PCL) data, and/or any other printer language data. The print controller 140 processes the sheet image to generate a bitmap 150 for transmission. The bitmap 150 includes the instructions (e.g., instructed ink drop size and/or instructed pel forming element location) for the one or more printheads 162 and pel forming elements 165. Bitmap 150 may be a halftoned bitmap (e.g., a compensated halftone bit map generated from compensated halftones, or uncompensated halftone bit map generated from uncompensated halftones) for printing to the print medium 180. The printing system 130 may be a high-speed printer operable to print relatively high volumes (e.g., greater than 100 pages per minute).

The print medium 180 may be continuous form paper, cut sheet paper, and/or any other tangible medium suitable for printing. The printing system 130, in one generalized form, includes the printer 160 that presents the bitmap 150 onto the print medium 180 (e.g., via toner, ink, etc.) based on the sheet image 120. Although shown as a component of printing system 130, other embodiments may feature printer 160 as an independent device communicably coupled to print controller 140.

The print controller 140 may be any system, device, software, circuitry and/or other suitable component operable to transform the sheet image 120 for generating the bitmap 150 in accordance with printing onto the print medium 180. In this regard, the print controller 140 may include processing and data storage capabilities. In one embodiment, measurement module 190 is implemented as part of a compensation system to obtain measurements of the printed medium 180. The measured results are communicated to print controller 140 to be used in a compensation process. The measurement system may be a stand-alone process or be integrated into the printing system 130.

According to one embodiment, measurement module 190 may be a sensor to take measurements of printed images on print medium 180. Measurement module 190 may generate and transmit measurement data 222. Measurement data 222 may be OD (e.g., optical density), perceptual lightness (e.g., L* in the CIELAB color plane L*a*b*) and/or scanned image (e.g., RGB) data corresponding to a printed image. In one embodiment, measurement module 190 may comprise one or more sensors that each or in total take measurements for printed markings produced for some or all pel forming elements 165. In another embodiment, measurement module 190 may be a camera system, in-line scanner, densitometer, or spectrophotometer.

In a further embodiment, measurement data 222 may include map information to correlate portions of the measurement data to the corresponding pel forming elements 165 that contributed to the printing of the portions of the measurement data. In another embodiment, the print instructions for a test chart (e.g., step chart or test master) along with the known printer design provides the correlation (e.g., mapping) of the portions of the measurement data 222 to the corresponding pel forming elements 165 that contributed to the printing of the portions of the measurement data.

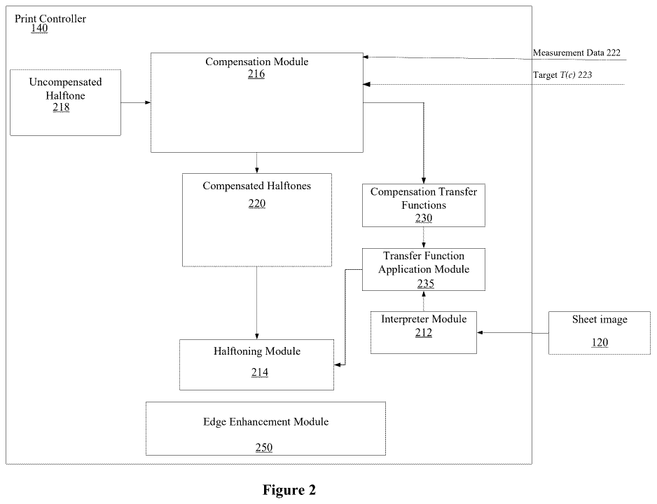

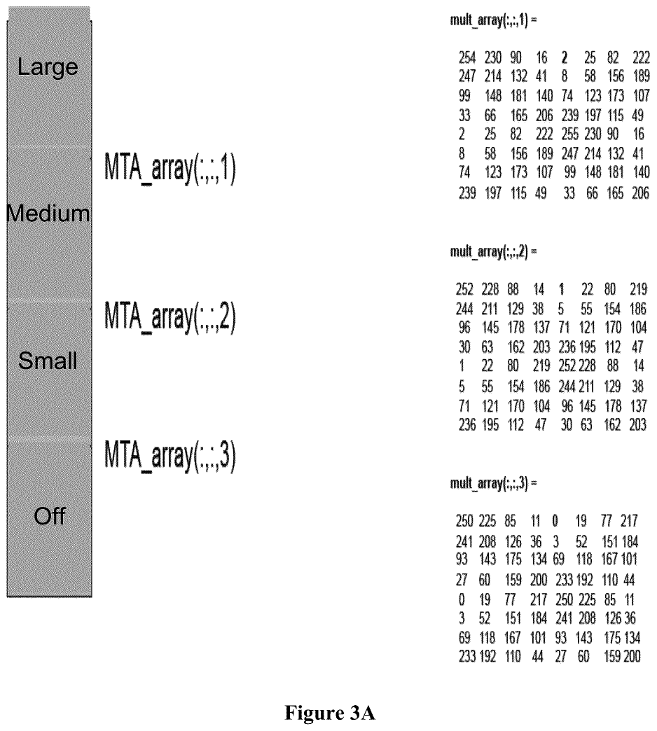

FIG. 2 is a block diagram illustrating one embodiment of a print controller 140. The print controller 140, in its generalized form, includes an interpreter module 212, a halftoning module 214, and a compensation module 216. These separate components may represent hardware used to implement the print controller 140. Alternatively, or additionally, the separate components may represent logical blocks implemented by executing software instructions in a processor of the printer controller 140.

Interpreter module 212 is operable to interpret, render, rasterize, or otherwise convert images (e.g., raw sheetside images such as sheet image 120) of a print job into sheetside bitmaps (e.g., contone images). The sheetside bitmaps generated by the interpreter module 212 for each primary color are each a 2-dimensional array of pels representing an image of the print job (e.g., a Continuous Tone Image (CTI)), also referred to as full sheetside bitmaps. The 2-dimensional pel arrays are considered “full” sheetside bitmaps because the bitmaps include the entire set of pels for the image. Interpreter module 212 is operable to interpret or render multiple raw sheetsides concurrently so that the rate of rendering substantially matches the rate of imaging of production print engines. In one embodiment, transfer functions may be implemented by print controller 140 and applied directly to image data as a part of the image processing prior to printing. In that case, CTI is transformed by the transfer functions prior to halftoning.

Halftoning module 214 is operable to represent the sheetside bitmaps as halftone patterns of ink. For example, halftoning module 214 may convert the pels (also known as pixels) to halftone patterns of CMYK ink for application to the paper. A halftone design may comprise a pre-defined mapping of input pel gray levels to output drop sizes based on pel location.

In one embodiment, the halftone design may include a finite set of transition thresholds between a finite collection of successively larger instructed drop sizes, beginning with zero and ending with a maximum drop size (e.g., none, small, medium and/or large). The halftone design may be implemented as threshold arrays (e.g., halftone threshold arrays) such as single bit threshold arrays or multibit threshold arrays). In another embodiment, the halftone design may include a three-dimensional look-up table with all included gray level values.

In a further embodiment, halftoning module 214 performs the multi-bit halftoning using the halftone design comprising a set of threshold values for each pel in the sheetside bitmap, where there is one threshold for each non-zero ink drop size. The pel is halftoned with the drop size corresponding to threshold values for that pel. The set of thresholds for a collection of pels is referred to as a multi-bit threshold array (MTA).

Multi-bit halftoning is a halftone screening operation in which the final result is a selection of a specific drop size available from an entire set of drop sizes that the print engine is capable of employing for printing. Drop size selection based on the contone value of a single pel is referred to as “Point Operation” halftoning. The drop size selection is based on the contone pel values in the sheetside bitmap.

This contrasts with “Neighborhood Operation” halftoning, where multiple pels in the vicinity of the pel being printed are used to determine the drop size. Examples of neighborhood operation halftoning include the well-known error diffusion method.

Multi-bit halftoning is an extension of binary halftoning, where binary halftoning may use a single threshold array combined with a logical operation to decide if a drop is printed based on the contone level for a pel. Binary halftoning uses one non-zero drop size plus a zero drop size (i.e., a drop size of none where no ink is ejected). Multi-bit halftoning extends the binary threshold array concept to more than one non-zero drop size.

Multi-bit halftoning may use multiple threshold arrays (i.e., multi-bit threshold arrays), one threshold array for each non-zero drop size. The point operation logic is also extended to a set of greater than, less than, or equal to operations to determine the drop size by comparing the threshold and image contone data for each pel. Multi-bit defines a power of two set of drop sizes (e.g., two-bit halftone designs have four total drops, including a zero drop size). While power of two may be employed to define the number of drops, systems not following this such as a three total drop system may be used and are still considered multi-bit.

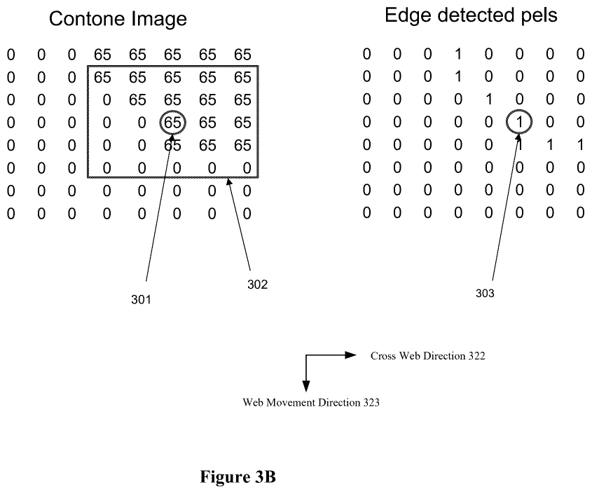

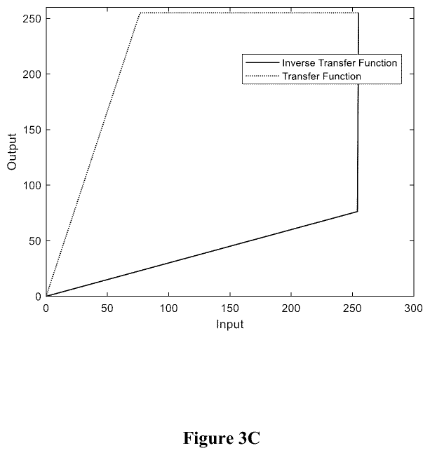

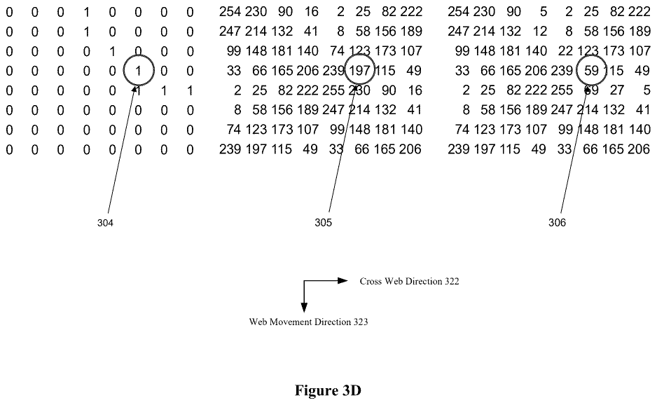

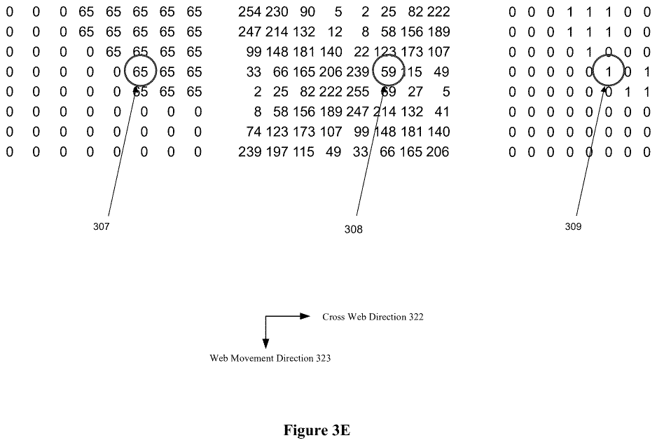

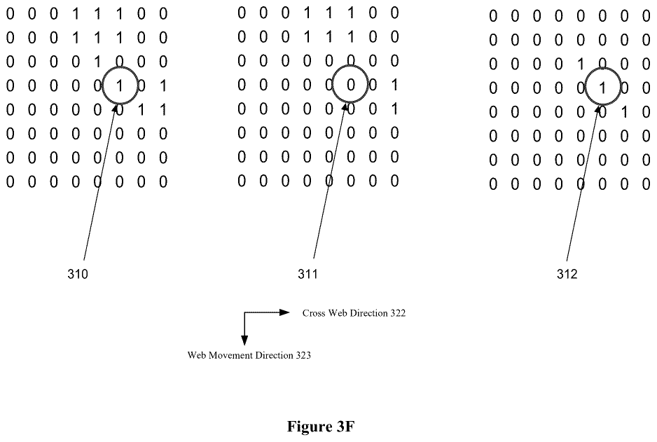

For multi-bit halftones, as shown in FIG. 3A, the MTA is a three-dimensional array including one two-dimensional array for each drop size transition. Thus, an MTA includes a set of two-dimensional arrays of thresholds for transition between drop sizes: plane one provides the threshold for the Large output level, while plane 2 and plane 3 provide thresholds for the Medium and Small output levels respectively for a system having three drop sizes not including zero drop size (none or off). In other embodiments, different one-to-one relationship may be used since the correspondence between plane numbers and drop sizes is arbitrary.

To use these threshold arrays for halftoning, in the case where the threshold arrays are smaller than the sheetside map, each multibit threshold array is tiled across contone image data provided by the sheetside bitmap, which provides a set of threshold values for each pel in the sheetside bitmap. The contone image data (e.g., gray level data) is logically compared to the threshold data on a pel basis. In one embodiment, halftoning module 214 produces large drops when the image contone data is greater than the respective large threshold values in plane 1.

Medium drops are produced when the image data is greater than the medium drop plane 2 thresholds and the image data is less than or equal to the large drop thresholds in plane 1. Small drops are produced when the image data is greater than the small drop thresholds in plane 3 and also the image data is less than or equal to the medium drop thresholds in plane 2.

Finally, the off/none drop size occurs for cases when the contone values is less than or equal to the small drop thresholds in plane 3. In this embodiment of a two-bit multibit printing system, this set of four logical equations, used with thresholds from each plane of the multibit threshold array permit each printing drop size to be defined, based on the contone values.

Alternate versions of the halftoning equations may also be defined. An example of an alternate set of halftoning logical expressions replaces the less-than-or-equal-to operation with less-than and replaces the greater-than operation is replaced with greater-than-or equal-to. A further variation of halftoning uses only the greater-than logical expressions starting with the test for the largest drop size first. The large drop is emitted if the continuous tone (e.g., 8-bit) value is greater than the large drop transition threshold for the pixel being tested. If a drop size is determined by this test, no more tests are performed. If a drop size is not found the process continues with the logical expression for the next smaller drop size. If the sequential test for each drop size does not find any drop size, the none drop size is assumed. The threshold arrays for each different set of halftoning equations will vary, and therefore the threshold arrays generated correspond to a given set of equations.

In other embodiments, the number of planes of threshold data may be extended to handle any number of drop sizes. The data from these two-dimensional arrays may be segmented into separate memory regions and stored in any convenient order. For example, the thresholds for each drop size transition may be stored contiguously in memory, and it is often advantageous to do so.

Compensation module 216 performs a compensation process on an un-compensated halftone 218, or previously generated uniformity compensated halftone, received at print controller 140 to generate one or more compensated halftones 220 to compensate for uniformity. Compensated halftones 220 are then received at halftoning module 214 along with the sheetside bitmap. In one embodiment, an un-compensated halftone 218 represents a reference halftone design that is modified to create the compensated halftones 220. In one embodiment, a compensated halftone 220 represents a compensated halftone design.

Compensated halftone 220 may be received or generated (e.g., generated based on target OD (e.g., target T(c) 223) versus input digital count data and measured OD versus output digital count data (e.g., measurement data 222)). In such an embodiment, measurements of the system response (e.g., measurement data 222) for a printed test chart are received via measurement module 190 using the un-compensated halftone 218 for printing a test chart.

Compensation module 216 also performs a compensation process to generate compensation transfer functions 230 to compensate for uniformity. Compensation transfer functions 230 are received at transfer function application module 235. Transfer function application module 235 applies the received compensation transfer functions 230 to print image data received from interpreter module 212 prior to performing halftoning at halftoning module 214.

In one embodiment, a transfer function comprises a mapping of an input digital count (or tint) to an output digital count for a system, where digital count (DC) is the gray level or color value representing the pels in a bitmap 150 (FIG. 1). Transfer functions may be received or generated (e.g., generated based on target OD (e.g., target T(c) 223) versus input digital count data and measured OD versus output digital count data (e.g., measurement data 222)). In such an embodiment, measurements of the system response (e.g., measurement data 222) for a printed test chart are received via measurement module 190 using the un-compensated halftone 218 for printing a test chart.

According to one embodiment, compensation module 216 may also be implemented to perform artifact (e.g., any combination of jet-out, deviated jet, defective jet, etc.) compensation for defective pel forming elements 165. As used herein, a jet-out is a print defect (e.g., pel forming element artifact) caused by a completely blocked ink jet nozzle and the result is no ink deposited on the print medium when the blocked ink jet nozzle is instructed to fire. A deviated jet is a print defect (e.g., pel forming element artifact) caused by a malfunctioning ink jet nozzle where the ink drops deposited on the print medium are offset or deviated from the position of a nominally functioning ink jet when the ink jet nozzle is instructed to fire.

Similar to uniformity compensation explained above, compensation module 216 may receive or generate jet-out compensation (e.g., nozzle defect compensation) as represented by jet-out compensation halftones or jet-out compensation transfer functions. Compensation module 216 may detect jet-outs and other artifacts based on printing pre-determined test patterns, analyzing corresponding received measurement data 222 (e.g., OD) for discrepancies between the expected printed test pattern pel locations and the measurement data, and associating the discrepancies with corresponding defective nozzles.

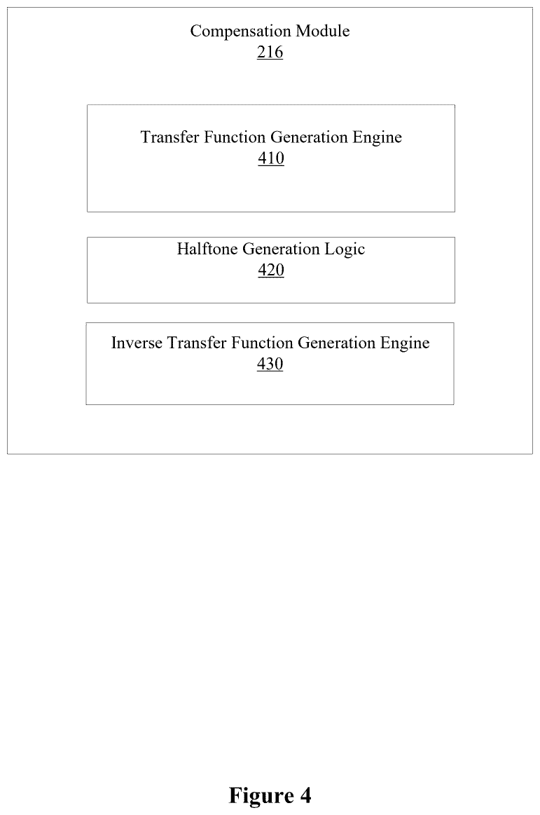

FIG. 4 illustrates one embodiment of compensation module 216. As shown in FIG. 4, compensation module 216 includes a transfer function generation engine 410 that is used to perform compensation by generating a uniformity compensation transfer function for each color plane. In one embodiment, the transfer functions may also include jet-out compensation transfer functions that are generated to compensate for defective pel forming elements 165.

According to one embodiment, compensation module 216 implements compensation transfer functions to adjust pel forming elements 165 proportional to its intrinsic density (e.g., uniformity) and/or adjust pel forming elements 165 adjacent (e.g., neighboring) to defective pel forming elements 165. In other words, compensation module implements nozzle compensation comprising uniformity compensation and/or jet-out compensation. The nozzle compensation contains uniformity and/or nozzle defect compensation that corresponds to nozzles and the responses of the nozzles. As will be explained further below, edge enhancement compensation corresponds to pels identified as edge pels in the contone image.

In a further embodiment, defective pel forming elements 165 associated with the defective column location are determined and are disabled from operating as a part of the jet-out (e.g., artifact) and/or deviated jet compensation, thereby ensuring that the defective pel forming element's 165 output is predictable and can be reliably compensated.

As mentioned above, compensation module 216 may also perform compensation using compensated halftones. Accordingly, halftone generation logic 420 may be implemented to generate compensated halftones for each color plane. In one embodiment, compensated halftones are generated by modifying the columns of thresholds in a threshold array associated with the halftoning of each pel forming element 165 for all drop sizes. In this embodiment, the compensated halftones include jet-out compensated halftones generated by modifying (e.g., adjusting) the thresholds corresponding to specific columns adjacent to the artifact, based on column location to pel forming element correspondence data. Additionally, specific columns of thresholds may be modified to inhibit ejection of drops such as in the case of jet-out or deviated jet compensation. In a further embodiment, columns extend along the web movement direction.

Inverse transfer function generation engine 430 generates inverse transfer functions that are used to generate compensated halftones. According to one embodiment, the inverse transfer functions are used (e.g., by compensation module 216) to transform thresholds in specific columns of the threshold arrays of un-compensated halftones to generate the compensated halftones. An inverse transfer function is the reversed (e.g., inverted) application of the transfer function, where the output digital count values of the transfer function form the input digital count values of the inverse transfer function and the input digital count values of the transfer function form the output digital count values of the inverse transfer function. The inverse transfer functions may be generated directly or from transfer functions by computing the mathematical inverse function of the transfer function. In one embodiment, inverse transfer functions may be received.

As mentioned above, edge enhancement may also be performed to enhance edge contrast of data to enhance print quality of text and images that are to be printed. In one embodiment, the first step in an edge enhancement process is to use an N×N pel (e.g., 5×5 when N=5) neighborhood edge detection algorithm that analyzes pels within the neighborhood region to determine if a pel of interest located at the center of the N×N region is an edge pel (e.g., a pel of interest with a non-zero contone value located next to a zero contone value pel considering all possible adjacent pels) using pattern recognition.

FIG. 3B illustrates one embodiment of an 8×8 pel contone image (the left array) having a pel of interest 301 (e.g., having a contone level of 65) within a 5×5 neighborhood 302. The result of the edge pel detection for this 8×8 contone image is shown in the 8×8 edge detected pels array (the right array) with array elements having logical one values where edges are detected and logical zero values where no edge is detected. As shown, pel 303 includes a logical one value indicating the contone image pel of interest 301 is an edge pel for the neighborhood region 302.

Cross web direction 322 indicates the direction across the web print medium in relation to the contone image, while web movement direction 323 (e.g., web path direction) indicates the print medium direction of travel in relation to the contone image. Typically, each column of the contone image corresponds to one of the pel forming elements 165. In another embodiment a small contone level value is used instead of the zero contone value to determine edge pels. In another embodiment, the neighborhood region is not square and may be diamond shaped.

Edge enhancement is performed on a pel of interest upon determining that the pel of interest is an edge pel. In one embodiment, edge enhancement involves applying an edge enhancement inverse transfer function (ITF) to the threshold value in a threshold array associated with a pel of interest. FIG. 3C illustrates one embodiment of an edge enhancement ITF and an edge enhancement transfer function with axes indicating input DC and output DC.

As shown in FIG. 3C, the TF is defined as a function that is linear having a slope that is greater than the slope of an identity TF (e.g., 1/0.3). The impact of such a TF is to darken the printing which is the objective in this case. The horizontal portion of the TF has an output level that is equal to the maximum threshold level not including the placeholder threshold. The edge enhancement ITF corresponding to the TF has an output that is 0.3 times the digital count value inputs (e.g., 0.3*DC).

Additionally, an exception is added to output the placeholder threshold value for a placeholder input level to ensure that placeholder thresholds remain as placeholder thresholds. In one embodiment, edge enhanced thresholds that equal the placeholder threshold correspond to none drop size output for any DC level. Placeholder values are employed to restrict the ink deposition level to avoid having individual pels that excessively ink a region.

Placeholder thresholds depend on the specific halftoning equation that are employed. The use of a placeholder value in the ITF addresses the mathematical one to one issue when computing the inverse of a function. A mathematical implementation to generate an inverse function is that the input function must satisfy a one to one input/output relationship. The addition of a placeholder threshold exception creates the correct ITF output that is needed for halftoning addressing the one to one correspondence requirement for cases where it is required. Similarly, the corresponding transfer function output is one over 0.3 times the DC (e.g., 1/0.3*DC) input.

FIG. 3D illustrates one embodiment of generating an edge enhanced threshold using the edge enhancement ITF and a detected edge pel 304 as reference. The left array is an 8×8 edge detected pels array, the middle array is an 8×8 unmodified large drop threshold array (e.g., a first compensated threshold array) and the right array is a corresponding 8×8 modified large drop threshold array (e.g., an edge enhanced threshold array). As explained above, the edge detected pels array identifies the corresponding threshold element of interest (e.g., 1 indicates an edge detected pel). At each edge detected pel location threshold modifications are generated using the original halftone thresholds as the input and producing replacement edge detected thresholds for the thresholds corresponding to the edge detected pel locations.

As shown in FIG. 3D, unmodified large drop thresholds are modified by applying an edge enhancement ITF to threshold elements corresponding to an edge detected pel (e.g., threshold element 305 with threshold value=197) within the unmodified threshold array. Transformation of the unmodified threshold value using the edge enhancement ITF generates an edge enhanced threshold value 306 (e.g., threshold value=59). Note that unmodified threshold array elements not corresponding to an edge detected pel remain unchanged in the edge enhanced threshold array. In one embodiment, this process is repeated for each one of the drop sizes as defined by the different planes of the threshold array to obtain edge enhanced thresholds for medium size drops and small size drops.

FIG. 3E illustrates one embodiment of the halftoning results for large drops. The left array is an 8×8 contone image, the middle array is an 8×8 modified large drop threshold array (e.g., an edge enhanced threshold array) and the right array is an 8×8 large drop halftoned result (where a value of 1 indicates that a large drop symbol has been determined as a result of halftoning). As shown in FIG. 3E, pel of interest 307 (e.g., an edge pel) results in a large drop size after halftoning indicated by large drop symbol 309, using a contone level 65 defined by pel of interest 307 and threshold value 59 defined by 308; assuming halftoning equations where large drop when contone level>large drop threshold value. In one embodiment, this process is repeated for each one of the drop sizes as defined by the different planes of the threshold array to obtain edge enhanced thresholds for medium size drops and small size drops

Halftoning for each drop size using the edge enhanced thresholds produces the respective drop sizes for each plane of the threshold array. The result is a single drop size for each pel of interest employing the edge enhanced thresholds. Each pel that is not edge enhanced is printed with the same drop size that would have been used without edge enhancement.

FIG. 3F illustrates halftone results for large drops with and without edge enhancement. The left array is an 8×8 large drop halftone result with edge enhancement applied, the middle array is an 8×8 large drop halftone result without edge enhancement applied, and the right array is an 8×8 comparison of halftone results. Pel of interest 310 is the halftone result (e.g., large drop produced) generated from performing the above-described edge enhancement, while pel 311 shows the halftone result (e.g., large drop not produced) without edge enhancement. The differences in the halftoned results between using the edge enhancement process and not using this process is shown in corresponding pel 312, where logical one value indicates a pel having a different resulting large drop size. The results for other pels in this 8×8 example are also shown. This example illustrates how additional ink (e.g., large drops) has been added to enhance the regions identified as edges.

As is apparent, transforming the threshold using the edge enhancement ITF modifies prior uniformity compensation and/or jet-out compensation processes performed at compensation module 216. Accordingly, an edge enhancement module 250 is included within print controller (FIG. 2) to perform edge enhancement processing.

In embodiments, edge enhancement may need to be performed for different types of edge features (e.g., different types of edges, lines or isolated features). However, conventional enhancement mechanisms have limited functionality regarding edge enhancement for different types of edge features (e.g., edge enhancement is not based on edge features). Moreover, conventional enhancement mechanisms may interact unpredictably with nozzle compensation data (e.g., jet-out compensation and/or uniformity compensation).

According to embodiments, edge enhancement module 250 is implemented to identify an edge type of each pel of interest and perform pel processing on the pels of interest based on the identified edge type. In such an embodiment, edge enhancement module 250 performs feature detection processing to identify a plurality of edge pels within a plurality of pels in a continuous tone image (CTI), assigns one of a plurality of pel edge symbols to each of the plurality of identified edge pels within the CTI and performs edge pel processing and nozzle compensation for each of the identified edge pels to generate final pel values by modifying pel values for the identified edge pels with edge enhancement compensation data corresponding to the indicated edge type and with corresponding nozzle compensation data. In a further embodiment, edge enhancement logic 250 performing edge pel processing comprises generating a final pel value for an identified edge pel by selecting an edge enhancement transfer function associated with the edge type from the edge enhancement compensation data, and applying the edge enhancement transfer function to the identified edge pel value. The resulting technical benefits include coordinated edge enhancement along with nozzle compensation and performing edge enhancement tailored to the edge type.

In an alternative embodiment, edge enhancement module 250 performs feature detection processing to identify a plurality of edge pels within a plurality of pels in a continuous tone image (CTI), assigns one of a plurality of pel edge symbols to each of the identified pels within the CTI and performs nozzle compensation and edge pel processing for each of the identified edge pels to generate final halftone designs by modifying halftone designs for the identified edge pels with corresponding nozzle compensation data and with edge enhancement compensation data corresponding to the indicated edge type. In this embodiment, edge enhancement logic 250 performing edge pel processing comprises generating a final halftone design for an identified edge pel by selecting an edge enhancement inverse transfer function associated with the edge type from the edge enhancement compensation data, and applying the edge enhancement inverse transfer function to a threshold value of a halftone design of the identified edge pel. The resulting technical benefits include coordinated edge enhancement along with nozzle compensation and performing edge enhancement tailored to the edge type.

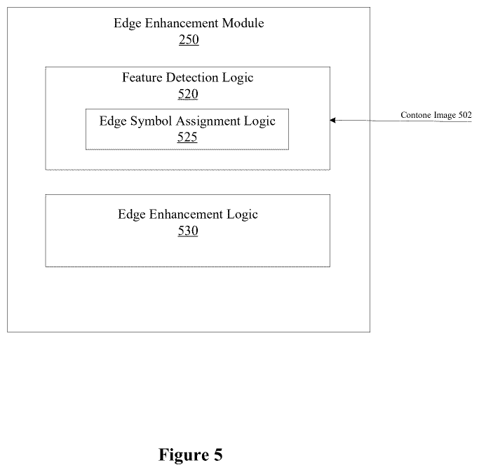

FIG. 5 illustrates one embodiment of edge enhancement logic 250. As shown in FIG. 5, edge enhancement logic 250 includes feature detection logic 520 to identify edge pels and identify an edge type associated with each edge pel. In one embodiment, feature detection logic 520 receives contone image 502 and detects (or identifies) edge pels in each color plane of the contone image 502 (or a binary image derived from contone image 502).

Feature detection logic 520 performs neighborhood processing of the contone image data on a pel-by-pel basis using a NxN pel (e.g., 5×5) neighborhood to detect edge pels using pattern recognition. To obtain edge detection for pels at the peripheral region of the contone image, padding of the contone image may be used with extra rows (y) and columns (x) to obtain a complete neighborhood for the pels of interest. This occurs due to a 5×5 neighborhood may extend beyond the available contone image pels when analyzing peripheral pels. Suitable padding levels are typically contone level zero. The resulting technical benefits include computational efficient feature detection.

Feature detection logic 520 also examines the pattern recognition of the 5×5 neighborhood (e.g., pattern matching) to identify edge pel types. In one embodiment, feature detection logic 520 implements a plurality of patterns to identify an associated pattern type. Identifying edge pel types by pattern matching include the technical benefit of improved computational efficiency. In such an embodiment, the plurality of patterns may include any combination of vertical or horizontal edges, diagonal edges, isolated lines, and isolated pels. Accordingly, identifying different edge types (e.g., vertical line vs horizontal lines) includes a technical benefit of facilitating corrections for anisotropic behavior or isolation. Anisotropic behavior is caused by drop smearing (e.g., convolution smearing) caused by print medium 180 movement or different resolutions in cross web and web movement directions. Anisotropic isolation is caused by sets of pels that have few adjacent pels.

Feature detection logic 520 includes edge symbol assignment logic 525 to assign an edge symbol to each identified edge pel. In one embodiment, a unique edge symbol is associated with each edge pel type. Thus, edge symbol assignment logic 525 assigns an edge symbol to an identified edge pel based on the type of edge pel identified. For example, a first edge symbol type may be assigned to a first type of identified edge pel and a second edge symbol type may be assigned to a second type of identified edge pel.

In a further embodiment, a None (or don't care) is implemented for instances in which the pattern matching result for a single pel in the pattern is not included in the comparison result for the entire 5×5 neighborhood. The match between each pel in the pattern is 0 for no match, 1 for match and in the case of don't care the result of the match is ignored. A pattern match occurs for the pel of interest for each 5×5 region when a match occurs for each pel in the pattern ignoring the don't care results.

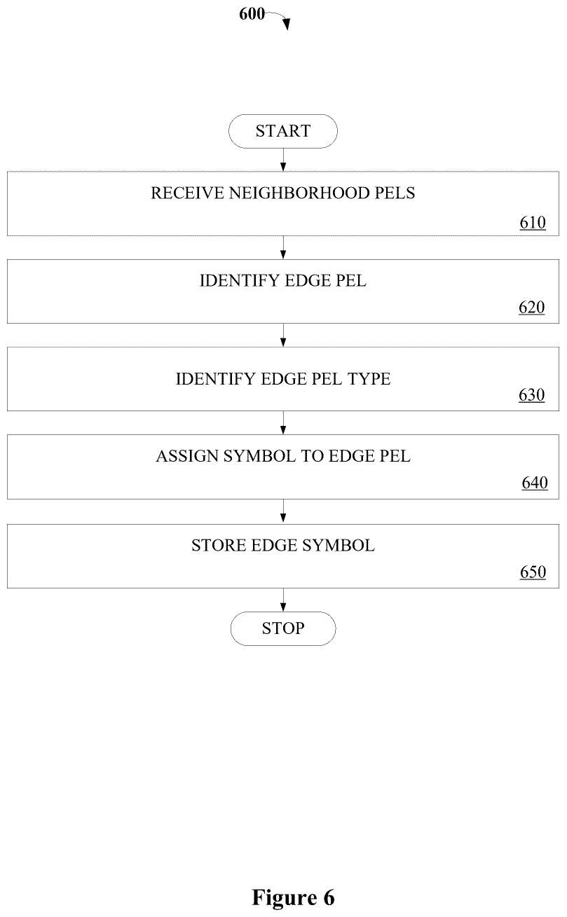

FIG. 6 is a flow diagram illustrating one embodiment of an edge identification process 600. Process 600 may be performed by processing logic that may include hardware (e.g., circuitry, dedicated logic, programmable logic, microcode, etc.), software such as instructions run on a processing device, or a combination thereof. Process 600 may be performed for each color plane of the contone image 502. In one embodiment, process 600 is performed by feature detection logic 520.

Process 600 begins at processing block 610 where a neighborhood of pels (e.g., 5×5 neighborhood) is received. At processing block 620, an edge pel is identified within the neighborhood of pels. At processing block 630, the edge pel type is identified. At processing block 640, an edge symbol is assigned based on the edge pel type. At processing block 650, the associated edge symbol is stored.

In a further embodiment, feature detection logic 520 may also be implemented to identify print object type (e.g., smooth shade, text, graphics, etc.) the feature detection to employ when modifying the edges of the print object. In such an embodiment, feature detection logic 520 identifies a print object based on a received print object tag plane. As used herein, a print object plane classifies each pixel in a contone image as having been derived from a particular type of print object on a page. The print object type data is combined with the stored edge symbol for each pel to determine the edge modification that is applied for that pel. In this implementation the edge modification that is used not only depends on the specific type of edge but includes further information about the object type for each pel. The resulting technical benefits include the ability to tailor the edge modification to an object type and improved computational efficiency by using a print object tag plan.

Referring back to FIG. 5, edge enhancement logic 530 is implemented to perform edge enhancement processing for each pel in contone image 502 that is associated with an edge pel. In one embodiment, edge enhancement logic 530 selects edge enhancement compensation data based on edge (or edge and print object) type and applies the edge enhancement compensation data to modify identified edge pels, while the pels not associated with edge pels remain unmodified. As further explained below, edge enhancement logic 530 may apply edge enhancement compensation by modifying contone image pel values or by modifying halftone threshold values. This results in changes in the halftoned image to enhance the edges in the image.

Edge enhancement compensation data comprises a set of transfer functions (e.g., edge enhancement transfer functions) or a set of inverse transfer functions (e.g., edge enhancement ITFs). The set of transfer functions include a transfer function to be applied to a contone image pel corresponding to each pel forming element 165 associated with an identified edge pel employing the edge symbol or edge symbol and object type. The set of inverse transfer functions include an inverse transfer function to be applied to threshold values of identified edge pels in a compensated halftone design. Where the transfer functions are derived as the mathematical inverse of the inverse transfer functions or vice versa. In one embodiment, edge enhancement compensation data may be generated at compensation module 216. However, in other embodiments the edge enhancement compensation data may be received from a source external to print controller 140.

As discussed above, identified edge pels are associated with one of a plurality of edge symbols based on the identified edge type. Additionally, each edge symbol may be associated with different edge enhancement compensation data. Thus in embodiments, each edge symbol is associated with an edge enhancement transfer function and edge enhancement ITF (e.g., a first edge enhancement transfer function or first edge enhancement ITF are associated with a first edge type and a second enhancement transfer function or second edge enhancement ITF are associated with a second edge type). As mentioned above, no enhancement is performed upon a determination that the type of edge cannot be identified (e.g., a third edge type, and/or the identified edge type is None). Thus, no edge enhancement transfer function and no edge enhancement ITF is selected for identified non-edge pels (e.g., edge pel processing bypasses applying a non-identity edge enhancement transfer function based on an indicated third edge type). The resulting technical benefits include providing for different edge enhancement compensation for different edge types and the ability to bypass edge processing when not needed.

In a further embodiment, edge enhancement may be controlled using different enhancement modes. In such an embodiment, each enhancement mode also includes an associated set of edge enhancement compensation data to achieve desired modifications. Accordingly, multiple edge enhancement transfer function/ITF sets may be used to obtain different degrees of enhancement for each mode. For example, a first enhancement mode (e.g., Mode 1) may be implemented to darken identified edge pels to reduce edge breakup (e.g., around text), while a second enhancement mode (e.g., Mode 2) may be implemented to lighten identified edge pels to affect the boldness of printing (e.g., changing stroke width) to improve 1D or 2D barcodes printed elements that are too wide). Resulting technical benefits include providing for different edge enhancement compensation for different modes.

According to one embodiment, edge enhancement logic 530 also facilitates edge enhancement by applying the edge enhancement compensation data and nozzle compensation data for identified edge pels, while applying nozzle compensation data (e.g., applying nozzle compensation data and foregoing application of edge enhancement compensation data) to non-edge pels. In this embodiment, nozzle compensation data comprises defective pel and/or uniformity compensation data associated with pel forming elements 165 to yield the technical benefit of compensating for defective pel/uniformity variations. Jet-out pel compensation disables defective pel forming elements 165 to avoid unintentional cleaning that may produce undesirable density variations in printed output. Nozzle compensation data may comprise a set (e.g., a plurality) of nozzle compensation transfer functions associated with pel forming elements 165 or a set (e.g., a plurality) of nozzle compensated halftone threshold arrays associated with pel forming elements 165. Nozzle compensation may be associated with pel forming elements 165 based on the predefined design of printing system 130. As used herein, the terms compensated (or corrected) may refer to transfer functions that are used to apply compensation to pels, or halftone threshold values on which compensation (e.g., uniformity compensation and/or jet-out compensation) has been performed (e.g., at compensation module 216).

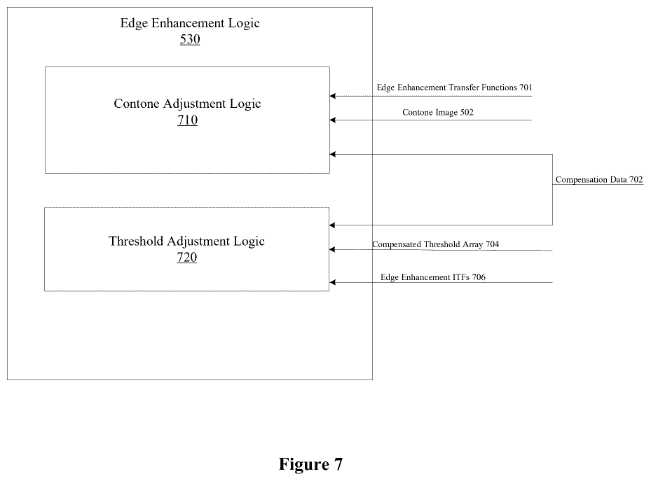

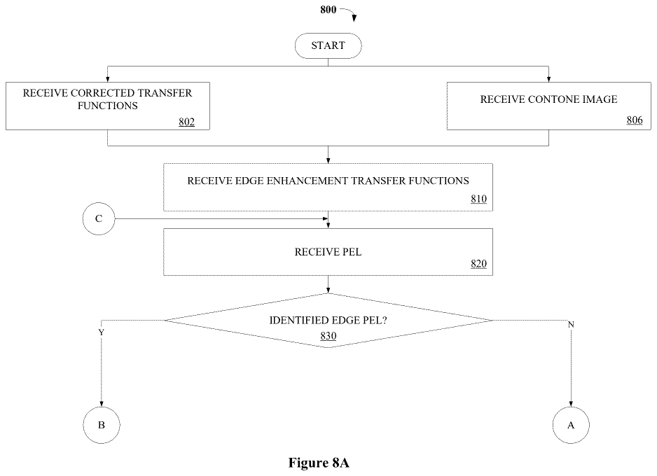

FIG. 7 illustrates one embodiment of edge enhancement logic 530. As shown in FIG. 7, edge enhancement logic 530 includes contone adjustment logic 710 and threshold adjustment logic 720. In one embodiment, contone adjustment logic 710 is implemented to generate modified image pels. In this embodiment, compensation transfer functions are employed that include uniformity and/or jet-out compensation to achieve ideal compensation. Accordingly, contone adjustment logic 710 receives compensation transfer functions (e.g., uniformity_JO TF(x, DC)) for each of the plurality of pel forming elements 165 associated with an image column (x) as compensation data 702 (e.g., nozzle compensation data), and contone image 502.

In one embodiment, compensation transfer functions form a set of transfer functions, one for each image column x, that transforms contone digital count levels (e.g., DC levels). Defective pel elements 165 have been disabled in the transfer functions (e.g., using zero level output values for all input levels DC in the transfer function or otherwise disabling the defective pel forming element).

Further modification to the compensation transfer functions may be performed using edge enhancement transfer functions 701 for the identified edge pels. In one embodiment, contone adjustment logic 710 retrieves an edge symbol type associated with an identified edge pel and selects a corresponding edge enhancement transfer function 701. In a further embodiment, contone adjustment logic 710 also selects the edge enhancement transfer functions 701 based on the current enhancement mode.

Contone adjustment logic 710 generates the modified (or final) pels (e.g., the modified contone level of the pels) by applying the compensation transfer functions and the edge enhancement transfer functions 701 to modify the contone image pel for each of the plurality of colors, contained in contone image 502, upon detection of an edge pel. As a result, the modified contone image at edge pel column, row (x, y) position may be represented as follows:

modified contone image(x,y)=uniformity_JO_TF(x, edgeEnhanceTF(contone(x,y))).

Here the contone image level for pel x, y without modification is contone(x, y), uniformity_JO_TF(x, DC) is the uniformity and jet-out compensated TF for the x column, and edgeEnhanceTF(DC) is the TF applied to edge detected pels. Subsequently, the edge enhanced image pels are transmitted for halftoning. In such an embodiment, since the edge enhancement has occurred by modifying the contone levels, the halftone drop sizes for edge enhanced image pels are obtained by halftoning the modified contone image using the uncompensated halftone 218.

As used herein, the above expression for compensation applied to the edge pel is a mathematical composite of the nozzle compensation transfer functions and the edge enhancement compensation transfer functions. A technical benefit from a composite TF is that it can be used to modify pel values in one operation. Furthermore, another technical benefit is that the composite TF achieves a more compact form with reduced computational requirements. Contone adjustment logic 710 also generates compensated pels upon determining that the examined pel is not an edge pel. In this embodiment, the compensated non-edge pels are generated by applying the nozzle compensation transfer functions (e.g., compensation data 702) to the contone image 502 pels, such that:

modified contone image(x,y) pixel=uniformity_JO_TF(x, contone(x,y)).

The compensated pels are also transmitted for halftoning using the uncompensated halftone 218.

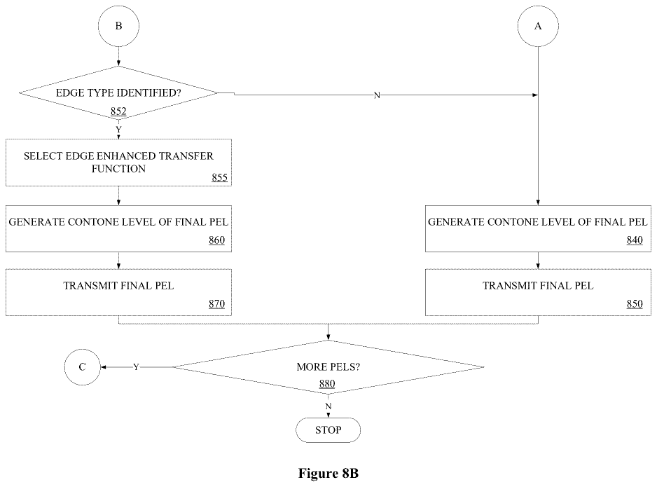

FIGS. 8A & 8B are flow diagrams illustrating one embodiment of an edge enhancement process 800. Process 800 may be performed by processing logic that may include hardware (e.g., circuitry, dedicated logic, programmable logic, microcode, etc.), software such as instructions run on a processing device, or a combination thereof. Process 800 may be performed for each color plane of the contone image 502. In one embodiment, process 800 is performed by edge enhancement module 250.

Process 800 begins at processing blocks 802 and 806 (FIG. 8A) where nozzle compensation (e.g., corrected) transfer functions (e.g., compensation data 702), and the contone image 502, respectively, are received. At processing block 810, the edge enhancement transfer functions 701 are received. At processing block 820, a pel is received. At decision block 830, feature detection is performed by determining whether a pel is an identified edge pel (e.g., as described in process 600). The contone level of a final pel is generated by applying the associated compensation transfer function to a corresponding pel in the contone image 502 upon determining that the pel is not an edge pel, processing block 840 (FIG. 8B). At processing block 850, the final pel is transmitted to be used for halftoning the pel. Subsequently, control is forwarded to decision block 880, which will be discussed below.

Upon a determination at decision block 830 that the pel is an edge pel, it is further determined whether an edge type has been identified, decision block 852. If not, control is returned to processing block 840 where the final pel is generated since no enhancement is performed for an unidentified edge type. An edge enhanced transfer function is selected, processing block 855, upon a determination that the edge pel type has been identified. As discussed above, an edge enhanced transfer function is selected based on an edge symbol associated with the type of edge pel that has been identified and/or a current enhancement mode.

At processing block 860, the contone level of a final pel is generated by applying the associated compensation transfer function and an edge enhancement transfer function 701 to a corresponding pel in the contone image 502. At processing block 870, the final pel is transmitted for halftoning the pel. Subsequently, control is forwarded to decision block 880. At decision block 880, a determination is made as to whether there are additional pels to process. If not, process 800 has been completed. Otherwise, control is returned to processing block 820 where another pel is received (FIG. 8A).

According to one embodiment, edge enhancement logic 530 is also implemented to perform edge enhancement by modifying (e.g., adjusting) each edge threshold in a compensated halftone threshold array using the edge enhancement ITF to generate final data upon detecting an edge pel. Referring back to FIG. 7, threshold adjustment logic 720 generates edge enhancement thresholds using received compensated threshold array 704 (e.g., uniformityJO compensated ThresholdArray (x′,y′,k), nozzle compensated threshold array) as the compensation data 702 for each of the plurality of pel forming elements 165. Here x′ and y′ correspond to the coordinates of pel within the threshold array and k is the drop size, whereas different threshold arrays exist for each different drop size k.

Compensated threshold array 704 is a representation of compensated halftones 220. In one embodiment, threshold adjustment logic 720 generates the final thresholds upon identification of an edge pel and selection of an ITF based on the identified edge pel type. In this embodiment, threshold adjustment logic 720 uses received edge enhancement ITFs 706 to modify thresholds in the compensated threshold array 704 for each of a plurality of colors. As a result, the edge enhancement compensation data for an edge pel may be represented as follows:

modifiedThresholds(x′,y′,k)=edgeEnhanceITF(uniformityJOCompensatedThresholdArray (x′,y′,k)).

As discussed above, threshold adjustment logic 720 retrieves an edge symbol type associated with an identified edge pel and selects the corresponding edge enhancement ITF 706 based on the edge symbol type and/or a current enhancement mode.

Threshold adjustment logic 720 also includes the unmodified compensated thresholds in the modified compensated threshold array 704 upon determining that an examined pel is not an edge pel since the compensated threshold array 704 already includes the ideal compensations for the non-edge pel forming element 165, including placeholder thresholds that prevent any drops from firing due to the pel forming element 165 being defective.

In a further embodiment threshold adjustment logic 720 generates a composite ITF, where the composite ITF combines the threshold modifications of the uniformity JO threshold modification with the threshold modifications associated with the edge inverse transfer functions. A technical benefit from a composite ITF is that it can be used to modify thresholds in one operation. Furthermore, another technical benefit is that the composite ITF achieves a more compact form with reduced computational requirements. The final halftone threshold for the edge pel is generated by modifying the initial uncalibrated halftone design by transforming the corresponding threshold using a composite ITF formed by the edge enhancement inverse transfer function and a nozzle compensation inverse transfer function.

In the case of employing a composite ITF the threshold array 704 would be uncompensated and the composite ITF formed from edge enhancement ITF 706 and JO compensation ITF received from 702:

compositeITF(threshold)=edgeEnhanceITF(uniformity_JO ITF(threshold))

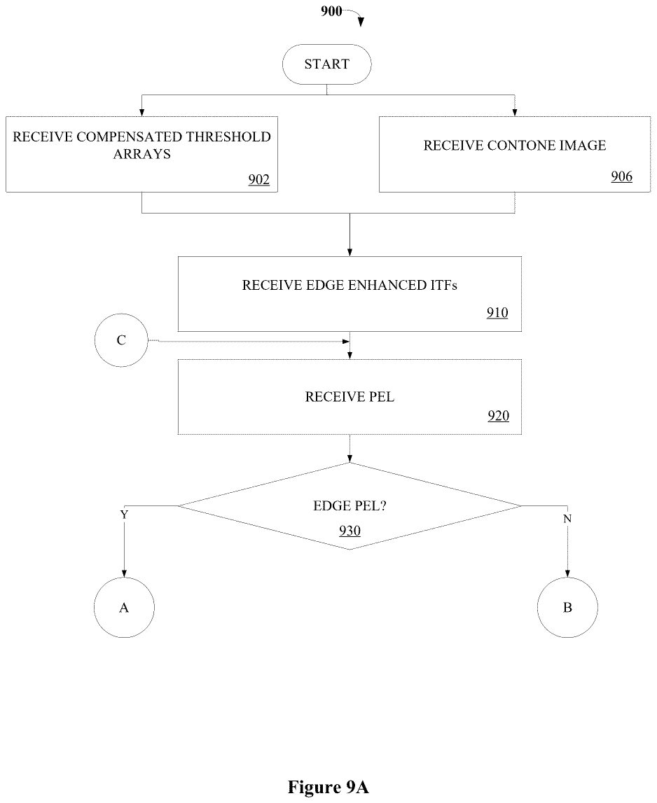

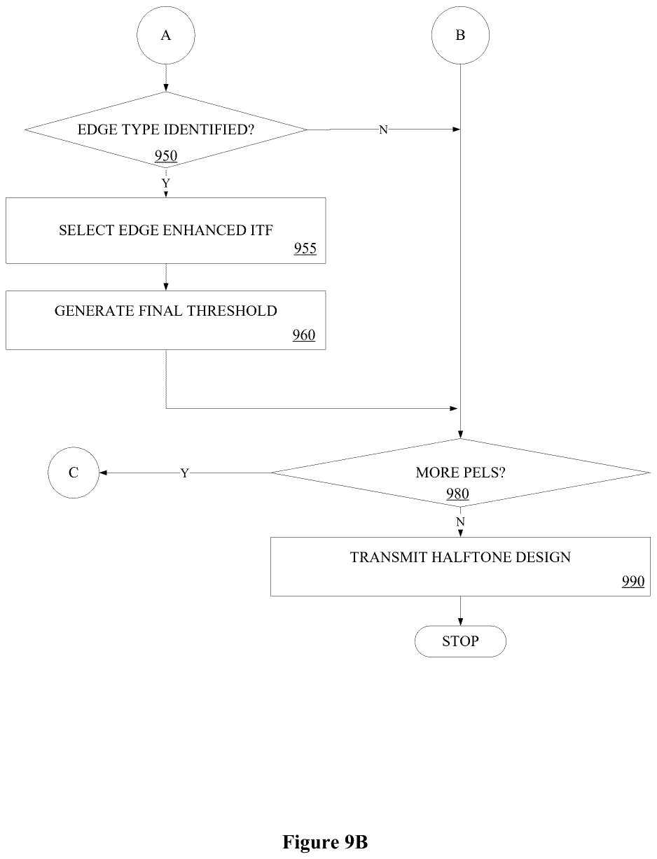

Here the compositeITF is generated using the uniformity_JO ITF associated with each nozzle location and the edgeEnhanceITF for each different edge detect feature. FIGS. 9A & 9B are flow diagrams illustrating one embodiment of an edge enhancement process 900. Process 900 may be performed by processing logic that may include hardware (e.g., circuitry, dedicated logic, programmable logic, microcode, etc.), software such as instructions run on a processing device, or a combination thereof. In one embodiment, process 900 is performed by edge enhancement module 250. Process 900 may be performed for each color plane of the contone image 502 and for every drop size in the final threshold array.

Process 900 begins at processing blocks 902 and 906 (FIG. 9A) where a compensated threshold array and the contone image 502, respectively, are received. As mentioned above, the compensated threshold array includes uniformity and jet-out compensations but does not include any edge enhancement. At processing block 910, the edge enhancement ITFs 706 are received. At processing block 920, a pel is received. At decision block 930, feature detection is performed by determining whether a pel is an identified edge pel. If not, a threshold in the compensated threshold array is to be used for halftoning the pel (FIG. 9B). Subsequently, control is forwarded to decision block 980, which will be discussed below.

Upon a determination at decision block 930 that the pel is an edge pel, it is further determined whether an edge type has been identified, decision block 950. If not, control is returned to processing block 980. Otherwise, an edge enhanced ITF is selected, processing block 955 (FIG. 9B). As discussed above, an edge enhanced ITF is selected based on an edge symbol associated with the type of edge pel that has been identified and/or a current enhancement mode. At processing block 960, a final threshold is generated using the edge enhancement ITFs 706 to modify the corresponding threshold in the compensated threshold array.

The generated edge enhanced threshold is used to replace the corresponding threshold in the compensated threshold array to be used for halftoning the pel. Therefore, the compensated threshold array for a compensated halftone design that is used for halftoning includes edge enhanced thresholds that have been modified or thresholds that remain the same based on edge detection. Subsequently, control is forwarded to decision block 980. At decision block 980, a determination is made as to whether there are additional pels to process. If not, the final thresholds or final halftone design is transmitted, processing block 990, and process 900 has been completed. Otherwise, control is returned to processing block 920 (FIG. 9A) where another pel is received.

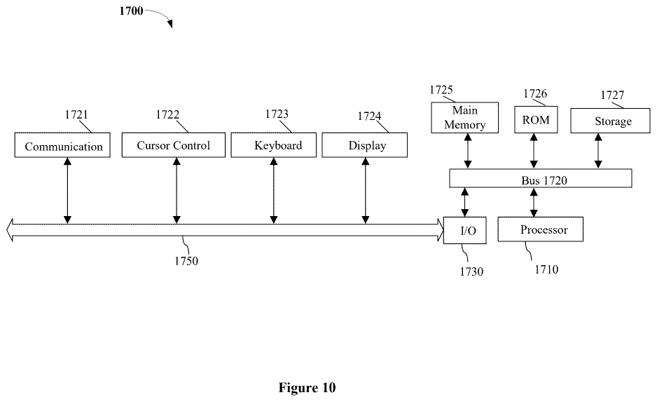

FIG. 10 illustrates a computer system 1700 on which printing system 130 and/or compensation module 216 may be implemented. Computer system 1700 includes a system bus 1720 for communicating information, and a processor 1710 coupled to bus 1720 for processing information.

Computer system 1700 further comprises a random-access memory (RAM) or other dynamic storage device 1725 (referred to herein as main memory), coupled to bus 1720 for storing information and instructions to be executed by processor 1710. Main memory 1725 also may be used for storing temporary variables or other intermediate information during execution of instructions by processor 1710. Computer system 1700 also may include a read only memory (ROM) and/or other static storage device 1726 coupled to bus 1720 for storing static information and instructions used by processor 1710.

A data storage device 1727 such as a magnetic disk or optical disc and its corresponding drive may also be coupled to computer system 1700 for storing information and instructions. Computer system 1700 can also be coupled to a second I/O bus 1750 via an I/O interface 1730. A plurality of I/O devices may be coupled to I/O bus 1750, including a display device 1724, an input device (e.g., an alphanumeric input device 1723 and or a cursor control device 1722). The communication device 1721 is for accessing other computers (servers or clients). The communication device 1721 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes a system comprising at least one physical memory device to store edge enhancement logic and one or more processors coupled with the at least one physical memory device to execute the edge enhancement logic to perform feature detection processing to identify a plurality of edge pels within a plurality of pels in a continuous tone image (CTI), assign one of a plurality of pel edge symbols to each of the identified pels within the CTI and perform nozzle compensation and edge pel processing for each of the identified edge pels to generate final halftone designs by modifying halftone designs for the identified edge pels with corresponding nozzle compensation data and with edge enhancement compensation data corresponding to the indicated edge type.

Example 2 includes the subject matter of Example 1, wherein the edge enhancement logic performing edge pel processing comprises generating a final halftone design for an identified edge pel by selecting an edge enhancement inverse transfer function associated with the edge type from the edge enhancement compensation data, and applying the edge enhancement inverse transfer function to a threshold value of a halftone design of the identified edge pel.

Example 3 includes the subject matter of Examples 1 and 2, wherein a first edge enhancement inverse transfer function is associated with a first edge type and a second edge enhancement inverse transfer function is associated with a second edge type.

Example 4 includes the subject matter of Examples 1-3, wherein the first edge type is associated with a first pel enhancement mode and the second edge type is associated with a second pel enhancement mode different than the first pel edge enhancement mode.

Example 5 includes the subject matter of Examples 1-4, wherein edge pel processing bypasses applying a non-identity edge enhancement inverse transfer function based on an indicated third edge type.

Example 6 includes the subject matter of Examples 1-5, wherein feature detection processing is performed using neighborhood processing of the CTI.

Example 7 includes the subject matter of Examples 1-6, wherein the edge enhancement logic performing feature detection processing further comprises performing a pattern matching operation within a neighborhood of the identified edge pel to identify one of a plurality of edge types and set the pel edge symbol for the identified edge pel.

Example 8 includes the subject matter of Examples 1-7, wherein an edge type comprises at least one of: a vertical edge, a horizontal edge and a diagonal edge.

Example 9 includes the subject matter of Examples 1-8, wherein the edge enhancement logic performing feature detection processing further comprises performing print object detection to identify one of a plurality of print objects within the neighborhood of the identified edge pel, selecting one of a plurality of edge enhancement inverse transfer functions associated with the identified one print object and applying the one edge enhancement inverse transfer function.

Example 10 includes the subject matter of Examples 1-9, wherein the edge enhancement logic performing the print object detection further comprises receiving print object tag plane data classifying each pel in the CTI and identifying a print object within the neighborhood of the identified edge pel based on the print object tag plane data.

Example 11 includes the subject matter of Examples 1-10, wherein the final halftone design for the target pel is generated by modifying the halftone design by applying a composite of the edge enhancement inverse transfer function and a nozzle compensation inverse transfer function to the threshold value of the halftone design of the identified edge pel.

Example 12 includes the subject matter of Examples 1-11, wherein the nozzle compensation data comprises a plurality of compensation inverse transfer functions associated with each of the plurality of identified edge pels.

Example 13 includes the subject matter of Examples 1-12, wherein the at least one physical memory device further to store halftoning logic and the one or more processors execute the halftoning logic to perform a halftoning operation on the final pel values.

Example 14 includes the subject matter of Examples 1-13, further comprising a print engine to print an output image based on the pel final values.

Some embodiments pertain to Example 15 that includes at least one computer readable medium having instructions stored thereon, which when executed by one or more processors, cause the processors to perform feature detection processing to identify a plurality of edge pels within a plurality of pels in a continuous tone image (CTI), assign one of a plurality of pel edge symbols to each of the identified pels within the CTI and perform nozzle compensation and edge pel processing for each of the identified edge pels to generate final halftone designs by modifying halftone designs for the identified edge pels with corresponding nozzle compensation data and with edge enhancement compensation data corresponding to the indicated edge type.

Example 16 includes the subject matter of Example 15, wherein performing edge pel processing comprises generating a final halftone design for an identified edge pel by selecting an edge enhancement inverse transfer function associated with the edge type from the edge enhancement compensation data and applying the edge enhancement inverse transfer function to a threshold value of a halftone design of the identified edge pel.

Example 17 includes the subject matter of Examples 15 and 16, wherein a first edge enhancement inverse transfer function is associated with a first edge type and a second edge enhancement inverse transfer function is associated with a second edge type.

Some embodiments pertain to Example 18 that includes a method comprising performing feature detection processing to identify a plurality of edge pels within a plurality of pels in a continuous tone image (CTI), assigning one of a plurality of pel edge symbols to each of the identified pels within the CTI and performing nozzle compensation and edge pel processing for each of the identified edge pels to generate final halftone designs by modifying halftone designs for the identified edge pels with corresponding nozzle compensation data and with edge enhancement compensation data corresponding to the indicated edge type.

Example 19 includes the subject matter of Example 18, wherein performing edge pel processing comprises generating a final halftone design for an identified edge pel by selecting an edge enhancement inverse transfer function associated with the edge type from the edge enhancement compensation data and applying the edge enhancement inverse transfer function to a threshold value of a halftone design of the identified edge pel.

Example 20 includes the subject matter of Examples 18 and 19, wherein a first edge enhancement inverse transfer function is associated with a first edge type and a second edge enhancement inverse transfer function is associated with a second edge type.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A system comprising:
at least one physical memory device to store edge enhancement logic; and
one or more processors coupled with the at least one physical memory device to execute the edge enhancement logic to:
perform feature detection processing to identify a plurality of edge pels within a plurality of pels in a continuous tone image (CTI);
assign one of a plurality of pel edge symbols to each of the identified pels within the CTI; and
perform nozzle compensation and edge pel processing for each of the identified edge pels to generate final halftone designs by modifying halftone designs for the identified edge pels with corresponding nozzle compensation data and with edge enhancement compensation data corresponding to the indicated edge type.

2. The system of claim 1, wherein the edge enhancement logic performing edge pel processing comprises generating a final halftone design for an identified edge pel by selecting an edge enhancement inverse transfer function associated with the edge type from the edge enhancement compensation data, and applying the edge enhancement inverse transfer function to a threshold value of a halftone design of the identified edge pel.

3. The system of claim 2, wherein a first edge enhancement inverse transfer function is associated with a first edge type and a second edge enhancement inverse transfer function is associated with a second edge type.

4. The system of claim 3, wherein the first edge type is associated with a first pel enhancement mode and the second edge type is associated with a second pel enhancement mode different than the first pel edge enhancement mode.

5. The system of claim 3, wherein edge pel processing bypasses applying a non-identity edge enhancement inverse transfer function based on an indicated third edge type.

6. The system of claim 1, wherein feature detection processing is performed using neighborhood processing of the CTI.

7. The system of claim 1, wherein the edge enhancement logic performing feature detection processing further comprises performing a pattern matching operation within a neighborhood of the identified edge pel to identify one of a plurality of edge types and set the pel edge symbol for the identified edge pel.

8. The system of claim 7, wherein an edge type comprises at least one of: a vertical edge, a horizontal edge and a diagonal edge.

9. The system of claim 7, wherein the edge enhancement logic performing feature detection processing further comprises performing print object detection to identify one of a plurality of print objects within the neighborhood of the identified edge pel, selecting one of a plurality of edge enhancement inverse transfer functions associated with the identified one print object and applying the one edge enhancement inverse transfer function.

10. The system of claim 9, wherein the edge enhancement logic performing the print object detection further comprises receiving print object tag plane data classifying each pel in the CTI and identifying a print object within the neighborhood of the identified edge pel based on the print object tag plane data.

11. The system of claim 2, wherein the final halftone design for the target pel is generated by modifying the halftone design by applying a composite of the edge enhancement inverse transfer function and a nozzle compensation inverse transfer function to the threshold value of the halftone design of the identified edge pel.

12. The system of claim 2, wherein the nozzle compensation data comprises a plurality of compensation inverse transfer functions associated with each of the plurality of identified edge pels.

13. The system of claim 1, wherein the at least one physical memory device further to store halftoning logic and the one or more processors execute the halftoning logic to perform a halftoning operation on the final pel values.

14. The system of claim 1, further comprising a print engine to print an output image based on the pel final values.

15. At least one computer readable medium having instructions stored thereon, which when executed by one or more processors, cause the processors to:
perform feature detection processing to identify a plurality of edge pels within a plurality of pels in a continuous tone image (CTI);
assign one of a plurality of pel edge symbols to each of the identified pels within the CTI; and
perform nozzle compensation and edge pel processing for each of the identified edge pels to generate final halftone designs by modifying halftone designs for the identified edge pels with corresponding nozzle compensation data and with edge enhancement compensation data corresponding to the indicated edge type.

16. The computer-readable medium of claim 15, wherein performing edge pel processing comprises:
generating a final halftone design for an identified edge pel by selecting an edge enhancement inverse transfer function associated with the edge type from the edge enhancement compensation data; and
applying the edge enhancement inverse transfer function to a threshold value of a halftone design of the identified edge pel.

17. The computer-readable medium of claim 16, wherein a first edge enhancement inverse transfer function is associated with a first edge type and a second edge enhancement inverse transfer function is associated with a second edge type.

18. A method comprising:
performing feature detection processing to identify a plurality of edge pels within a plurality of pels in a continuous tone image (CTI);
assigning one of a plurality of pel edge symbols to each of the identified pels within the CTI; and
performing nozzle compensation and edge pel processing for each of the identified edge pels to generate final halftone designs by modifying halftone designs for the identified edge pels with corresponding nozzle compensation data and with edge enhancement compensation data corresponding to the indicated edge type.

19. The method of claim 18, wherein performing edge pel processing comprises:
generating a final halftone design for an identified edge pel by selecting an edge enhancement inverse transfer function associated with the edge type from the edge enhancement compensation data; and
applying the edge enhancement inverse transfer function to a threshold value of a halftone design of the identified edge pel.

20. The method of claim 19, wherein a first edge enhancement inverse transfer function is associated with a first edge type and a second edge enhancement inverse transfer function is associated with a second edge type.
